(19) United States
(12) Patent Application Publication
(10) Pub. No.: US 2013/0179183 A1
(43) Pub. Date: Jul. 11, 2013

(54) COMPUTER BASED STANDARDIZED METHOD AND APPARATUS FOR GUIDING DECISION SUPPORT FOR SURGICAL ANATOMIC PATHOLOGY OPERATIONS

(71) Applicant: Heidi E. Wagner, Buffalo, NY (US)

(72) Inventor: Heidi E. Wagner, Buffalo, NY (US)

(21) Appl. No.: 13/783,378

(22) Filed: Mar. 3, 2013

Related U.S. Application Data
(63) Continuation-in-part of application No. 12/890,139, filed on Sep. 24, 2010, now abandoned.
(60) Provisional application No. 61/245,468, filed on Sep. 24, 2009.

(51) Int. Cl. G06Q 10/06; G06Q 50/22

(52) U.S. Cl. CPC G06Q 10/0637; G06Q 50/22
USPC 705/2

(57) ABSTRACT

A computer-based method for guiding decision support for surgical anatomic pathology operations, including: displaying, using a GUI for at least one specially programmable computer, a list of human body organs or organ systems; displaying, using the GUI, a list including at least one specimen type applicable to a selected human body organ or organ system; populating, using the GUI and the processor, a field with instructions, from a plurality of instructions, for guiding a surgical anatomic pathology operation applicable to a selected specimen type; displaying, using the GUI and the processor, a dictation template with respective prompts and respective fields applicable to the surgical anatomic pathology operation; receiving, using the GUI, an input from the respective fields including data related to performance of the surgical anatomic pathology operation; and generating, using the processor, a pathology report for the existing patient or the new patient including the data.

### CROSS-REFERENCE TO RELATED APPLICATIONS

This application is a continuation in part of U.S. Utility patent application Ser. No. 12/890,139, filed Sep. 24, 2010 that claims the benefit from U.S. Provisional Application No. 61/245,468, filed Sep. 24, 2009, which is incorporated herein by reference.

### REFERENCE TO COMPUTER PROGRAM LISTING APPENDIX

The present application includes a computer program listing in ASCII text file format as follows. The computer program listing is hereby expressly incorporated by reference in the present application.

| Filename | Size | Date Created |
|---|---|---|
| form1.txt | 35 kb | Sep. 23, 2010 |
| form2.txt | 1 kb | Sep. 23, 2010 |
| form3.txt | 2 kb | Sep. 23, 2010 |

### FIELD OF THE DISCLOSURE

The present disclosure relates generally to a computer based method and system for guiding decision support for surgical anatomic pathology operations.

### BACKGROUND OF THE DISCLOSURE

U.S. Patent Application Publication No. 2008/0242953 (Dew et al.) discloses a computer-based method and system for presenting prompts for medical personnel performing patient examinations. This reference is directed to a diagnostic operation regarding a patient and has no teaching, suggestion, or motivation directed to surgical anatomic pathology operations, in particular, guiding decision support for surgical anatomic pathology operations.

U.S. Patent Application Publication No. 2009/0222746 (Chirica et al.) discloses a computer-based method and system for controlling workflow in a pathology laboratory. Chirica defines workflow as a path or an order of operations that a specimen may follow in a laboratory. Thus, any actual medical operations included in the workflow, for example, operations at a grossing station, can be considered “black boxes.” Chirica is concerned with how the black boxes are handled and there is no standardized teaching, suggestion, or motivation regarding what is happening inside the black boxes. For example, Chirica has no standardized teaching, suggestion, or motivation regarding how a surgical grossing operation is actually performed.

In fact, Chirica teaches away from providing any type of information regarding actual execution of a medical procedure, since Chirica is only concerned with the “black boxes” (operational/systemic concerns). For example, Chirica has no standardized teaching, suggestion, or motivation as to how a grossing operation is performed. Chirica is only concerned with the flow of a specimen, irrespective of the actual operations performed on the specimen, through a grossing station, that is, how the “black box” is handled. In fact, providing any type of instruction or information guiding decision support for surgical anatomic pathology operations in Chirica would change the principle of operation of Chirica (focusing on work flow information, which is at an entirely different level than actual medical operation procedures) and would render Chirica unsatisfactory for its intended purpose (controlling work flow), as such information as no bearing or relevance with respect to work flow and could only serve to confuse or hinder the control of work flow operations and add undesirable and unnecessary complexity and cost.

U.S. Patent Application Publication No. 2008/0249386 (Besterman et al.) teaches a computer-based method and system for providing instructions to control a patient's physiological status. This reference has no teaching, suggestion, or motivation applicable to standardized surgical anatomic pathology operations, in particular, guiding decision support for surgical anatomic pathology operations.

U.S. Patent Application Publication No. 2003/0061070 (Kelly et al.) teaches a computer-based method and system for medical training. This reference is directed to abstract, theoretical teaching, not to guidance for any type of actual medical operation, and has no teaching, suggestion, or motivation directed to surgical anatomic pathology operations, in particular, guiding decision support for surgical anatomic pathology operations.

### SUMMARY OF THE DISCLOSURE

According to aspects illustrated herein, there is provided a computer-based method for guiding decision support for surgical anatomic pathology operations, including: storing, in a memory element of at least one specially programmable computer, a plurality of instructions for guiding surgical anatomic pathology operations; receiving, using a graphical user interface (GUI) for the at least one specially programmable computer, an input selecting an existing patient or identifying a new patient; displaying, using the GUI and a processor for the at least one specially programmable computer, a list of human body organs or organ systems; receiving, using the GUI, an input selecting an organ or organ system from the list of human body organs or organ systems; displaying, using the GUI and the processor, a list including at least one specimen type applicable to the selected human body organ or organ system; receiving, using the GUI, an input selecting a specimen type from the list including at least one specimen type; populating, using the GUI and the processor, a first field with instructions, from the plurality of instructions, for guiding a surgical anatomic pathology operation applicable to the selected specimen type; displaying, using the GUI and the processor, a dictation template with respective prompts and respective fields applicable to the surgical anatomic pathology operation; receiving, using the GUI, an input from the respective fields including first data related to performance of the surgical anatomic pathology operation; and generating, using the processor, a pathology report for the existing patient or the new patient including the first data.

According to aspects illustrated herein, there is provided an embodiment of a computer-based apparatus and method for guiding decision support for surgical anatomic pathology operations, comprising a memory element for at least one specially programmable computer, a processor for the at least one specially programmable computer, and a graphical user interface (GUI) for the at least one specially programmable computer. The memory element is intended for storing a plurality of instructions for guiding surgical anatomic pathology operations. In an embodiment, the GUI provides an interface through which information such as data, observations and facts pertaining to the pathological tissue analysis is received and entered into the memory element of the programmable computer.

In another embodiment, a user through the GUI interface, inputs information, such as entering or selecting a patient's name. The computer-based apparatus may then display, using the processor, a list of human body organs or organ systems. The computer-based apparatus may then receive, from a user, an input selecting an organ or organ system from the list of human body organs or organ systems. A list comprising at least one specimen type, applicable to the selected human body organ or organ system, is generated using the processor and displayed. A specimen type is selected from the list and entered into the memory element. In an embodiment, the processor is used to match and identify the inputted information, i.e. a patient's name, organ system, specimen type, or other information with the previously stored information for guiding surgical anatomic pathology operations. In addition, previously stored information such as videos, pictures and technical pathological tissue information can be identified by the computer-based apparatus or system using the inputted information. Such information could be used for training or educational purposes. Furthermore, patient specific information, such as a patient's medical history or a patient's previously stored tissue pathology information could also be searched, identified, analyzed and displayed by the system based on organ system and specimen type information that is entered into the system.

In an embodiment, the processor is for populating, using the GUI, a first field with instructions, from the plurality of instructions, for guiding a surgical anatomic pathology operation applicable to the selected specimen type. In another embodiment, the processor may be used to perform one or more algorithms that enable the system to identify and associate previously stored information with entered specimen type information.

In an embodiment, the GUI is for displaying, using the processor, a dictation template with respective prompts and respective fields applicable to the surgical anatomic pathology operation. In another embodiment, the GUI is designed to receive an input from a user, such as information entered in respective fields, including first data related to specimen type, performance of the surgical anatomic pathology operation, pathological tissue identification and pathology tissue characterization information, including but not limited to tissue color, weight, dimension, position, and condition.

In an embodiment, the processor may be used to perform operations to identify, sort, search, compare and pathology information. This information may include procedure instructions, tissue sample data, video and photographic information used to assist and guide a pathologist through surgical anatomic pathology operations

### BRIEF DESCRIPTION OF THE DRAWINGS

The nature and mode of operation of the present disclosure will now be more fully described in the following detailed description of the disclosure taken with the accompanying drawing figures, in which:

FIGS. 1 through 13 illustrate embodiments of a graphical user interface screen showing a computer-based method and system for guiding decision support for surgical anatomic pathology operations.

FIG. 14 is an embodiment of a schematic block diagram of a computer-based system for guiding decision support for surgical anatomic pathology operations.

FIG. 15 shows a logic diagram illustrating an embodiment of an anatomic pathology operation decision of the present invention.

### DETAILED DESCRIPTION OF THE PREFERRED EMBODIMENT

It is to be understood that the disclosure is not limited to the disclosed aspects. Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It is to be understood that any methods, devices or materials similar or equivalent to those described herein can be used in the practice or testing of the disclosure.

“Grossing Differential” is defined herein as the macroscopic observations, and measured characteristics of tissue. The Grossing Differential may comprise the macroscopic manifestation of diseased tissue. An organ system may comprise the following: bone, breast, cardiovascular system, endocrine system, female reproductive system, gastrointestinal system, head and neck, hepatobiliary system, lymphoid bone marrow system, male reproductive system, pediatric perinatal system, pulmonary system, skin, soft tissue, or urinary system.

“Specimen type” is defined herein as a tissue dissection or biopsy. The specimen type may comprise a sample extracted from an organ or organ system of the human body. A “synoptic report” is defined herein as a structured reporting of findings and facts that uses a standardized content and definitions in a coherent clinically relevant and consistent way. The report allows the findings to be efficiently and effectively used in patient diagnosis, prognosis and treatment. As used with the present invention, a synoptic pathology report uses an electronic report structure that includes a discrete data field format. This arrangement allows a computer to search the database of reports in useful ways.

As used throughout, “memory element” is herein defined as electronic digital memory such as random access memory (RAM), read only memory (ROM) or a memory element may comprise a computer hard drive. “Computer” is herein defined as a device or system that is capable of processing digital data. A computer may comprise a stand-alone device or may comprise a network system capable of processing digital data. A stand-alone device may include, but is not limited to, a desktop computer, a laptop computer, a tablet device, a personal data assistant (PDA), a cellular phone, or other mobile device capable of processing digital data.

The present disclosure includes a computer-based method and apparatus or system 100 for guiding decision support for surgical anatomic pathology operations. The method and apparatus are directed to medical personnel, for example, Fellows, Residents, Pathologist Assistants and Pathologist Assistants students, who perform surgical anatomic pathology operations. In one embodiment, the method and apparatus enable individual medical facilities to customize pre-formatted standard template guidelines and forced data entry standardized dictations for gross surgical anatomic pathology. The method and apparatus can be used as a stand-alone apparatus or it can interface with current facility pathology software, for example, CoPathPlus Cerner, CoPath Sunquest, Cerner Classic, Cerner Millenium, and PowerPath/IMPAC.

In one embodiment, when initiating the standardized method and apparatus, the user can access an existing patient file by searching for the patient name, the medical record number, the social security number or the pathology surgical case number. In one embodiment, a user can create a new surgical pathology file for a new patient by entering a patient name, medical record number, social security number or other patient demographics, all following HIPAA compliance. Thus, the user can search through existing patient files or create a new patient file.

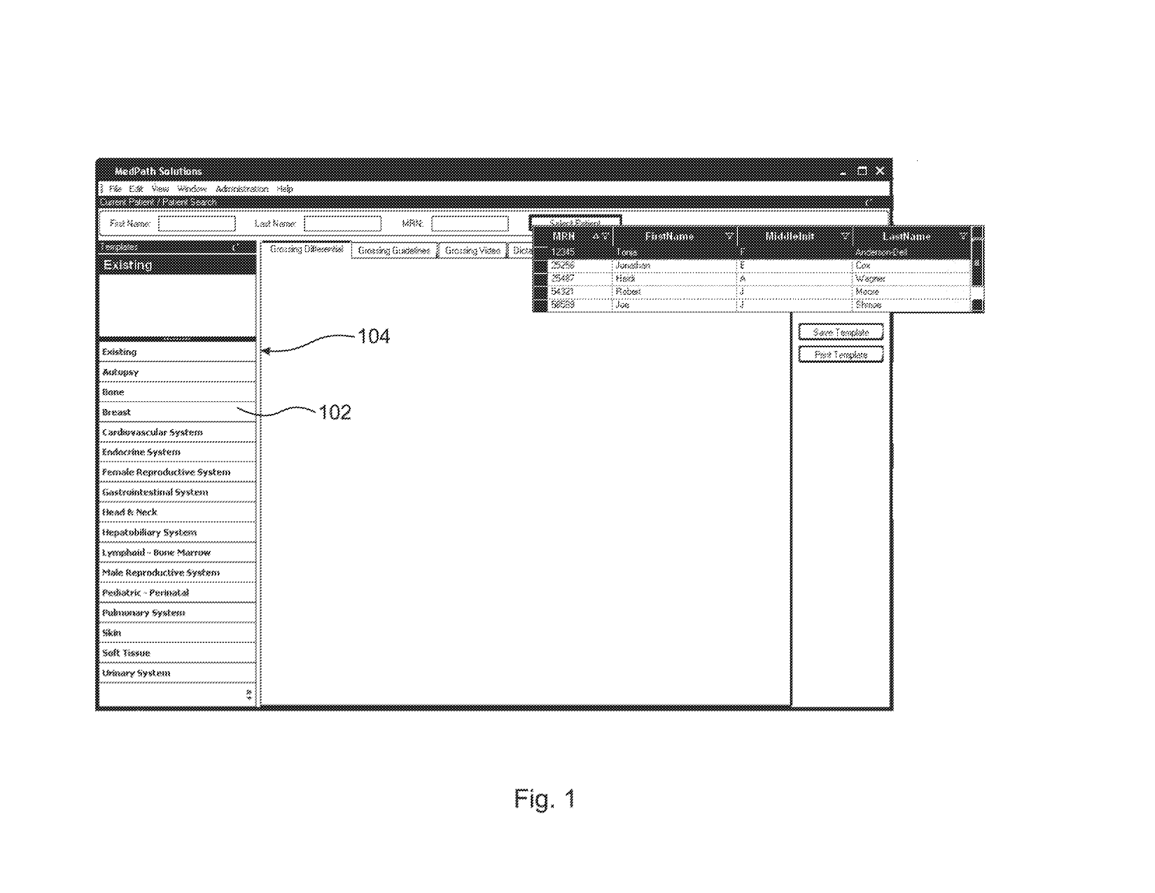

FIG. 1 illustrates an embodiment of a base screen for the standardized computer-based apparatus for guiding decision support for surgical anatomic pathology operations for trained medical personnel. This screen may be used to select an existing patient or create a file for a new patient. The discussion that follows is directed to an existing patient; however, it should be understood that the discussion is applicable to a new patient.

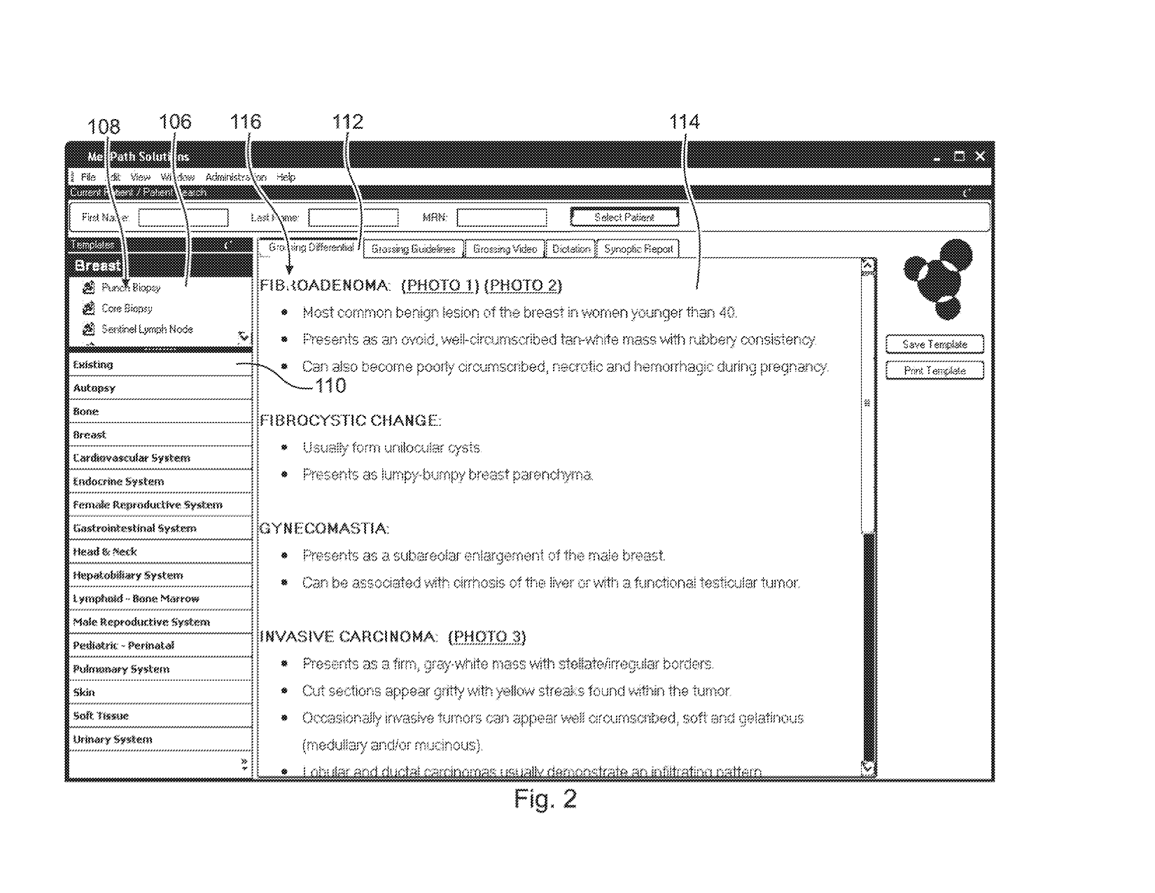

To generate the embodiment shown in FIG. 2, a user selects tab 102 for “Breast” from the listing of human body organs and organ systems in field 104 in the previous screen. Any organ or organ system known in the art can be included in field 104. As illustrated in the FIG. 1 embodiment, a new menu labeled “Breast” appears in field 106 above the listing in field 104. The new menu presents specimen types 108 in field 106. To view existing files regarding the selected patient tab 110 for “Existing” is selected. As illustrated in the embodiment of FIG. 2, a user has selected Tab 112 for “Grossing Differential” in As a result, field 114, the Grossing Differential field has been populated with information applicable to the organ or organ system selected in the previous figure, for example, the apparatus has populated the Grossing Differential viewing field with standardized prompts and differential information 116 applicable to a breast specimen. In an embodiment, this information may have been previously stored in a memory element or alternatively may be accessed from a remote location through the Internet or computer network. Standardized prompts and differential information 116 provide pictorial and standardized written descriptions regarding all possible non-neoplastic and neoplastic specimen type scenarios applicable to the selected organ or organ system.

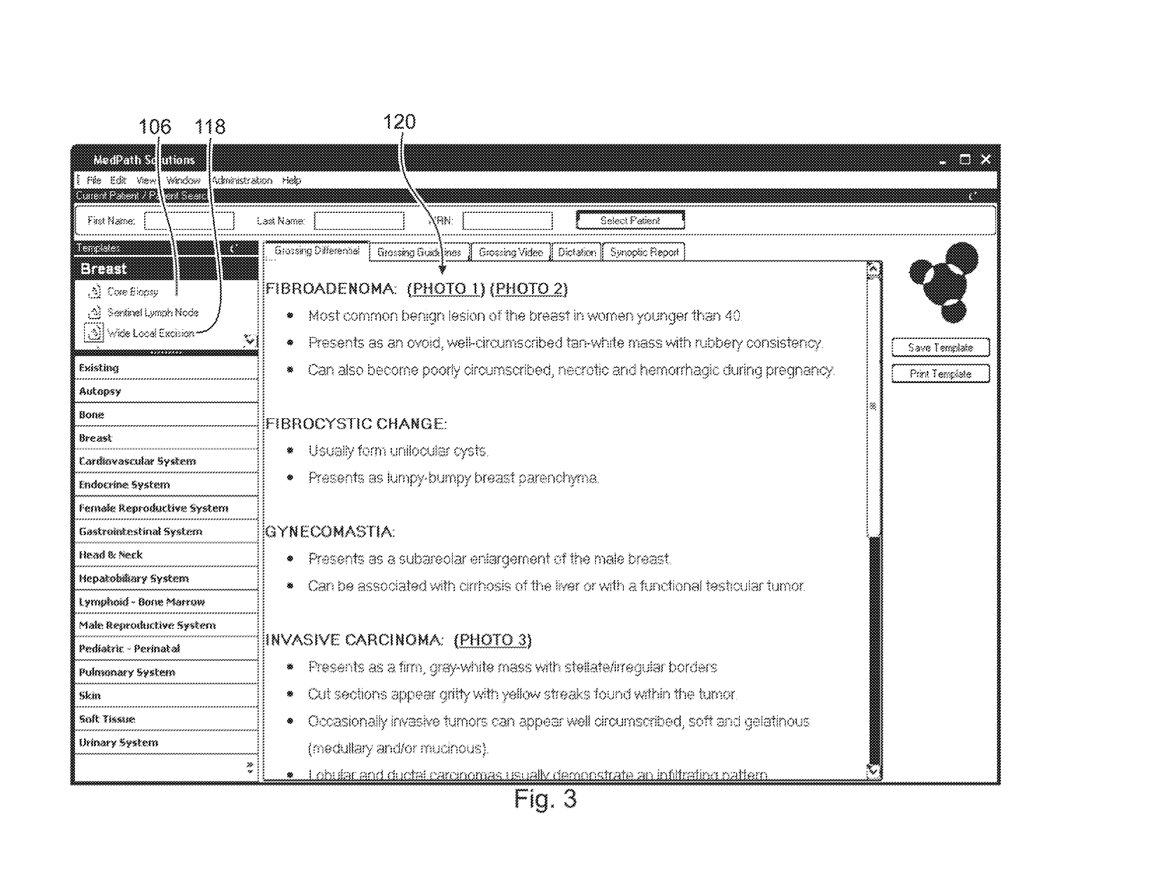

As shown in FIG. 3, a user has selected tab 118 for “Wide Local Excision” from the specimen option menu in field 106. In the example shown, standardized prompts and differential information 116 are the same for the organ or organ system selected and the specimen type selected. In some instances, standardized prompts and differential information 116 may change for the specimen type selected. Furthermore, applicable standardized prompts and differential information are presented in response to the selection of the specimen type. As will be discussed in more detail, the presentation and reporting of these standardized prompts and differential information may be determined based on specific tissue information that is entered by a user. Furthermore, the presentation and reporting of these prompts, instructions, differential information and related educational information may be custom tailored based on information entered by the user during a pathology analysis procedure.

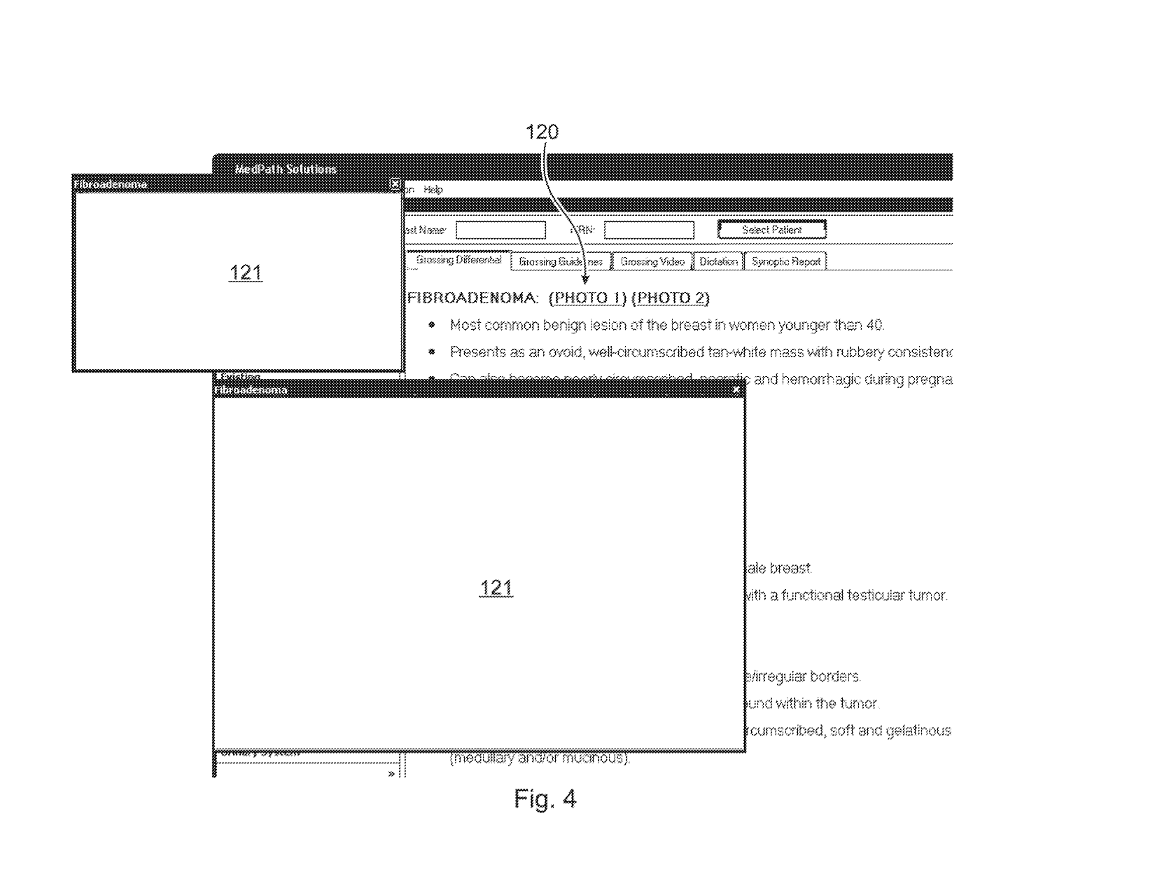

To generate the photographs shown in FIG. 4, a user has selected the photograph links in the viewing field, for example, PHOTO 1 or PHOTO 2 120, as shown in FIG. 3, as applicable to the selected organ or organ system. In one embodiment, standardized prompts and differential information 116 includes respective links to an interactive photograph of the affiliated typical gross photograph of the organ or organ system selected relating to the differential information. In FIG. 4, photographs would be displayed in blank fields 121. Any pictorial information known in the art can be displayed in fields creating a pathology specimen library within the apparatus. It should be understood that the present disclosure is not limited to the number of fields 121 shown.

In one embodiment, these interactive photo links, for example, PHOTO 1 or PHOTO 2, once opened, may provide a separate web based link enabling pathology case studies affiliated with the type of chosen interactive photo, for example in PHOTO 1-fibroadenoma. These case studies are accredited through any accrediting entity known in the art, such as American Association of Pathologists Assistants, American Society of Clinical Pathology, and College of American Pathologists. A user can complete these case studies, for example, a user answers questions presented as part of the case study, for purposes of obtaining continuing medical education credits. Thus, the present disclosure offers a mechanism for generating facility specific continuing medical education credits.

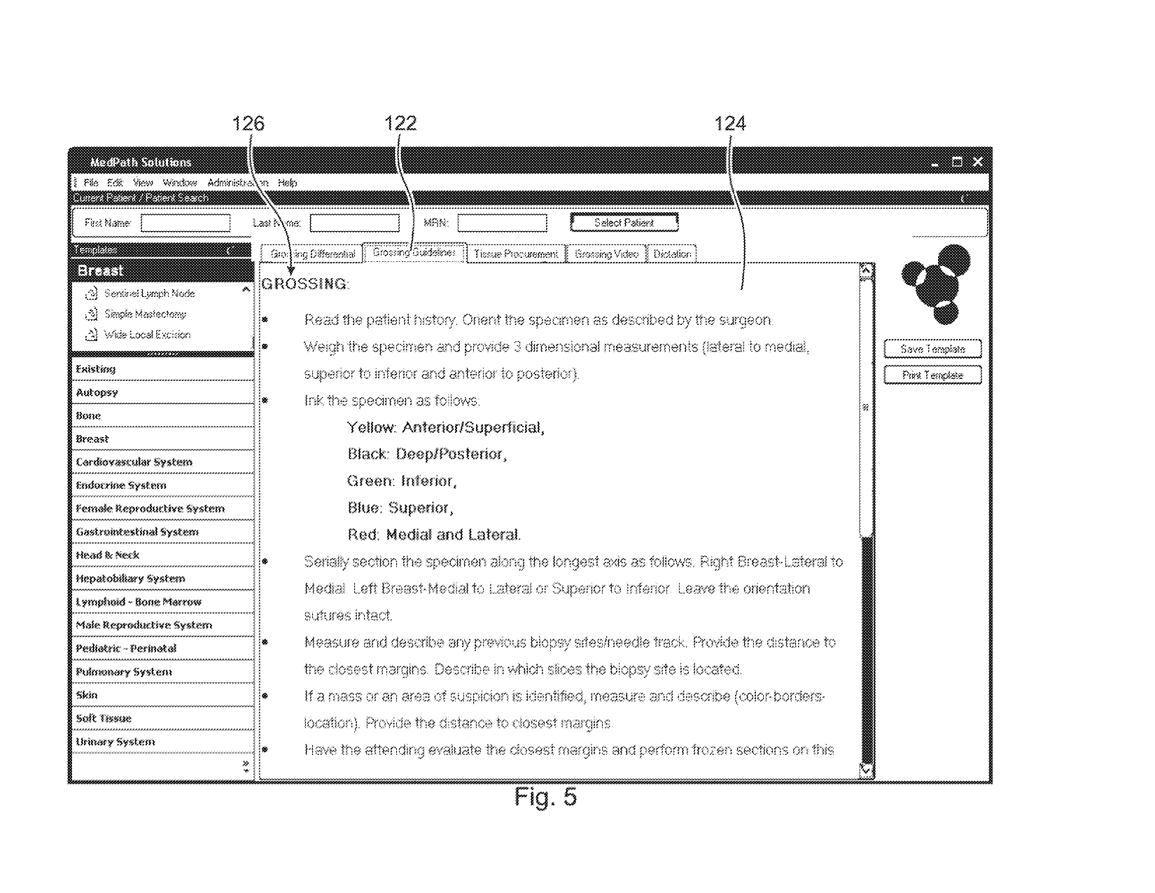

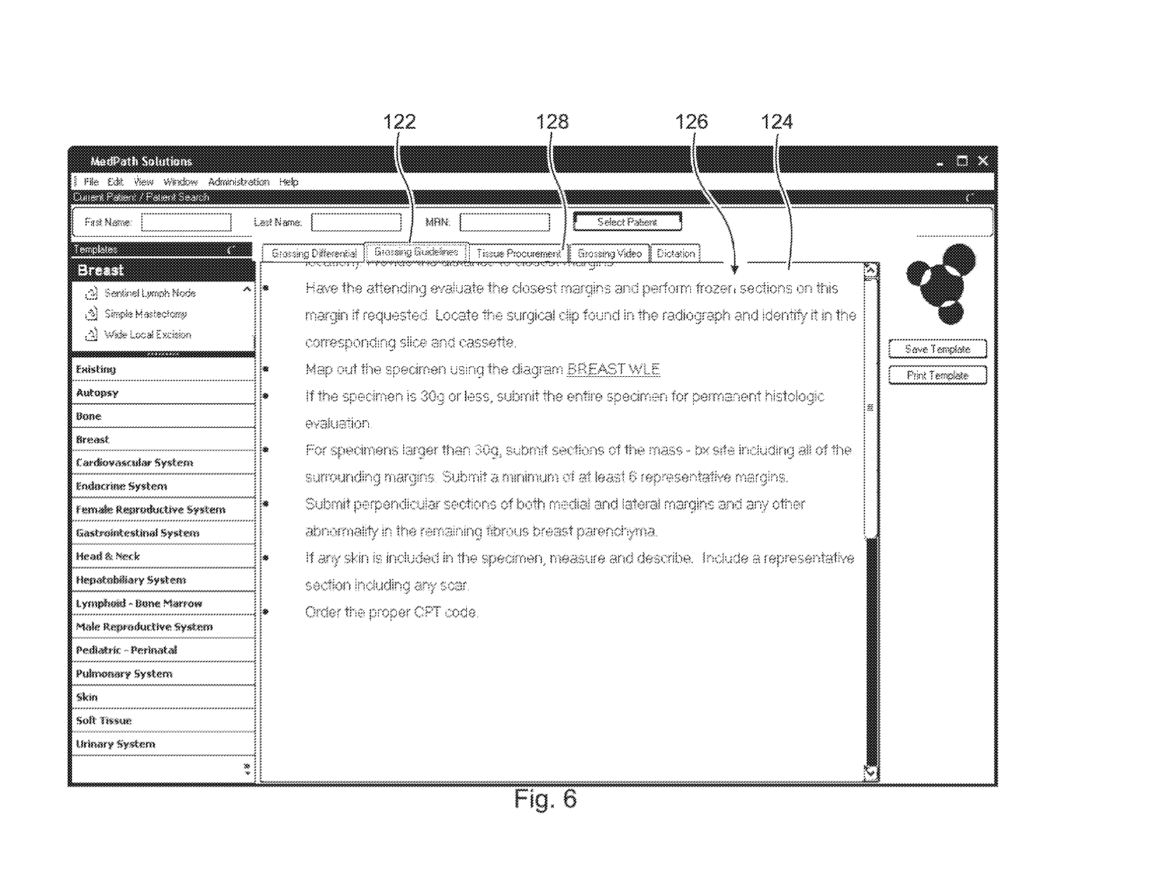

To generate FIGS. 5 and 6, a user has selected tab 122 for “Grossing Guidelines” in FIG. 5. Field 124, the Grossing Guidelines field, has been populated with standardized instructions, or guidelines, 126 for a surgical anatomic pathology operation applicable to the selected specimen type. In one embodiment, instructions or guidelines 126 assume the user is generally proficient or competent in surgical anatomic pathology operation procedures, and instructions or guidelines 126 direct or guide the user as to how to apply this proficiency or competence in a particular setting, specifically, for a particular surgical anatomic pathology operation. That is, instructions or guidelines 126 are not for training a user to obtain proficiency, but rather are for directing an already proficient user. As an analogy, instructions or guidelines 126 would not train a user as to how operate a motor vehicle, for example, make turns with the vehicle; but rather would guide the user as to where and when to turn the vehicle. In one embodiment, instructions or guidelines 126 do not assume that the user is generally proficient or competent in surgical anatomic pathology operation procedures, and instructions or guidelines 126 provide training and instruction to obtain this proficiency or competence, as well as directions for applying obtained proficiency or competence. In one embodiment, populated field 124 provides a detailed, facility customizable list of how to gross the chosen specimen. A suggested number of sections and required cassettes to be submitted for tissue processing is displayed according to the specimen type selected.

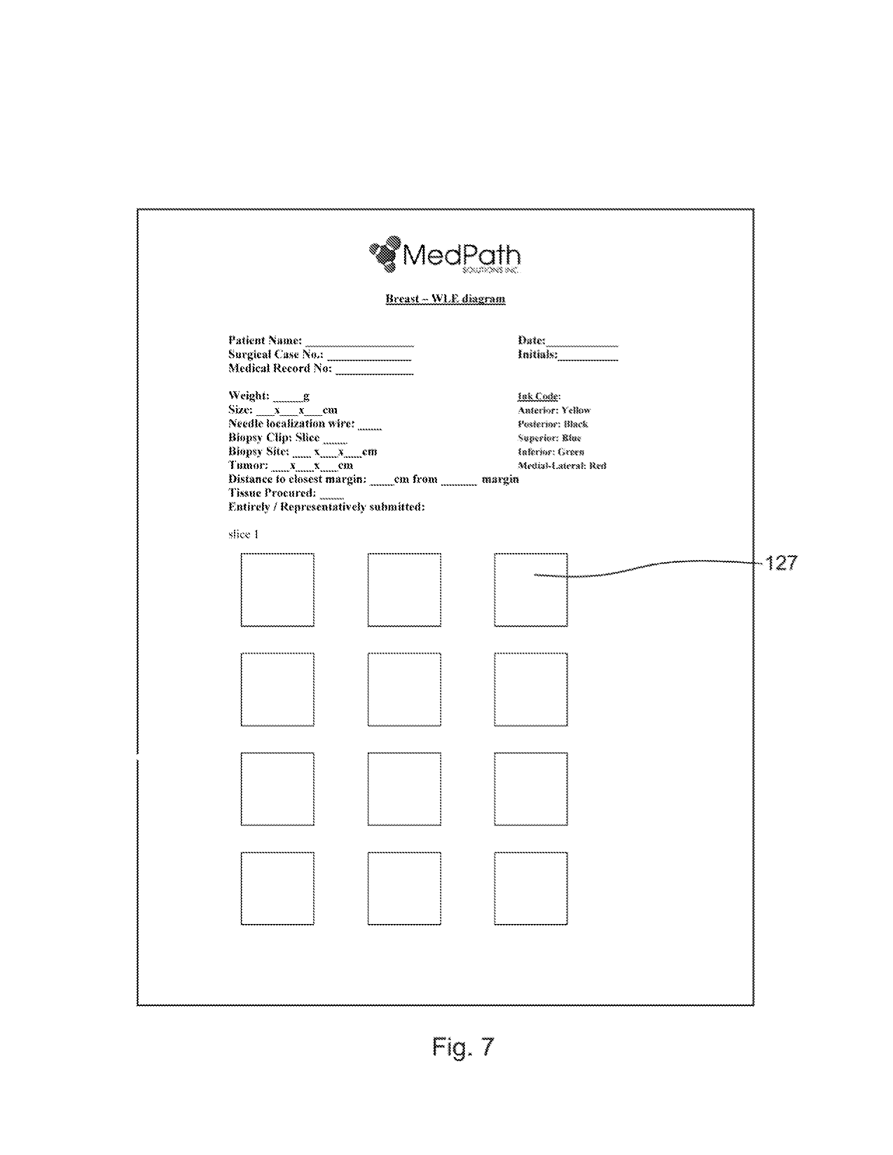

For the specimens that require an organ specific diagram-map, in this example, a Wide Local Excision organ specific diagram-map, a link to the diagram will automatically populate to generate the diagram shown in FIG. 7. Once the diagram is enabled, the patient demographics will populate on to the organ specific diagram-map along with the date of the pathology report and the user signature. A user can enable the print button allowing the user to print out the specimen diagram and map out the selected sections sampled from the specimen, for example, in fields 127. Once the organ specific diagram is completed, the user can input the diagram for inclusion in a patient file.

In one embodiment (not shown), a touch screen is used in the apparatus and the organ specific diagram-map selected via FIGS. 5 and 6 opens in “draw” section shown in FIG. 7 that can be completed on the screen and saved to the patient file. If the specimen is radiographed, the radiograph is accessible within the patient file and the user is able to map the specimen using touch screen capabilities.

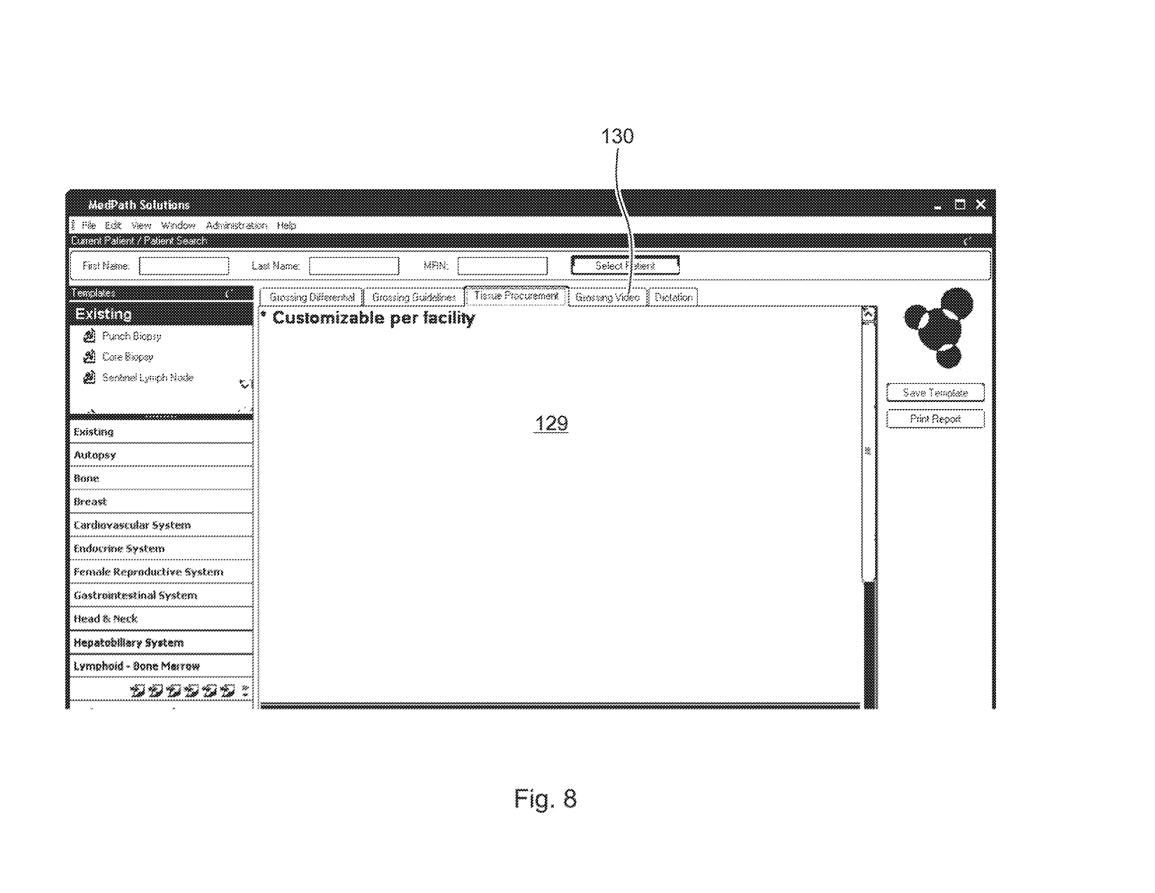

To generate FIG. 8, tab 128 for Tissue Procurement tab has been selected in FIG. 6. Facility customizable standardized instructions and protocols to procure tissue for research and clinical data analysis are presented in field 129. The standardized instructions and protocols are specimen type specific. Note that blank field 129 can be customized by a user to display any graphical presentation known in the art regarding tissue procurement.

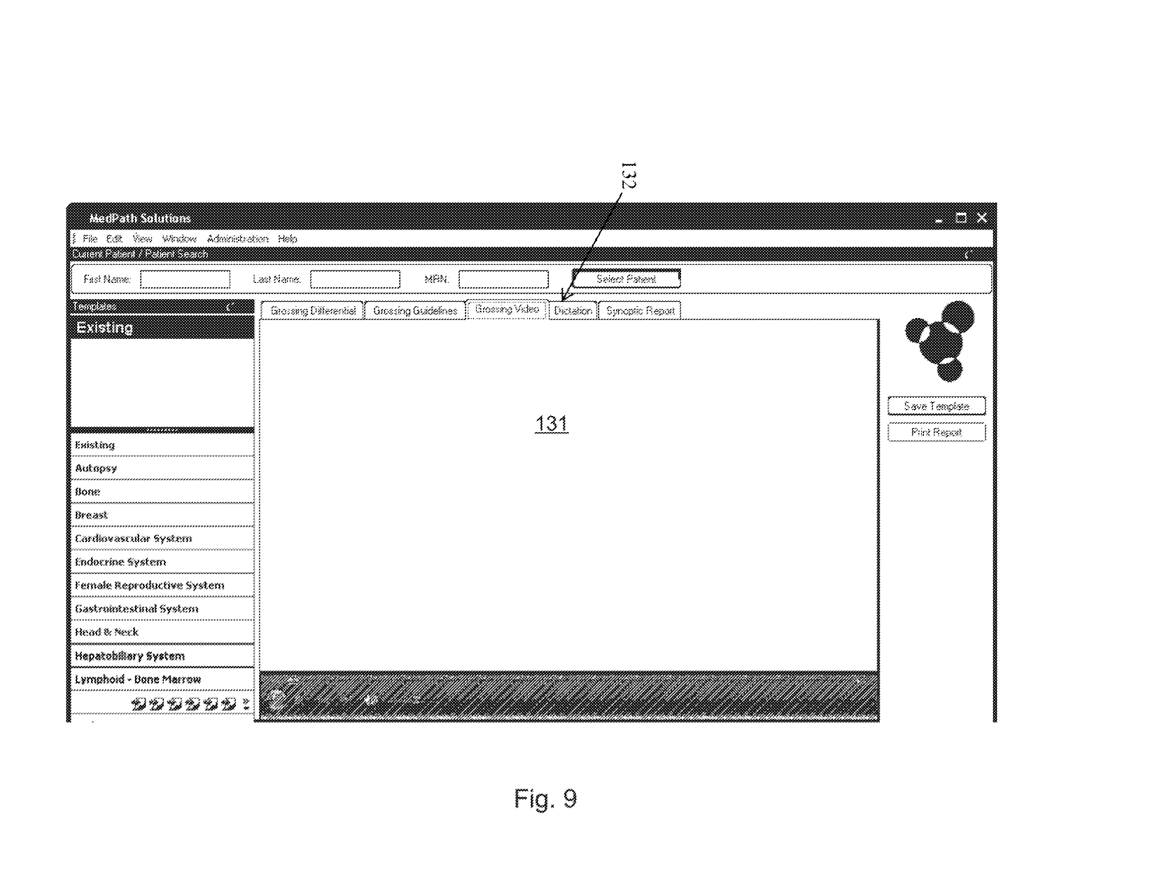

To generate FIG. 9, the user selected tab 130 for Grossing Video in FIG. 8. In FIG. 9, videos demonstrating how to gross the chosen specimen would be displayed in blank field 131. It should be understood that the present disclosure is not limited to the number of fields 131 shown. The video is presented using any means known in the art, for example, a flash media player.

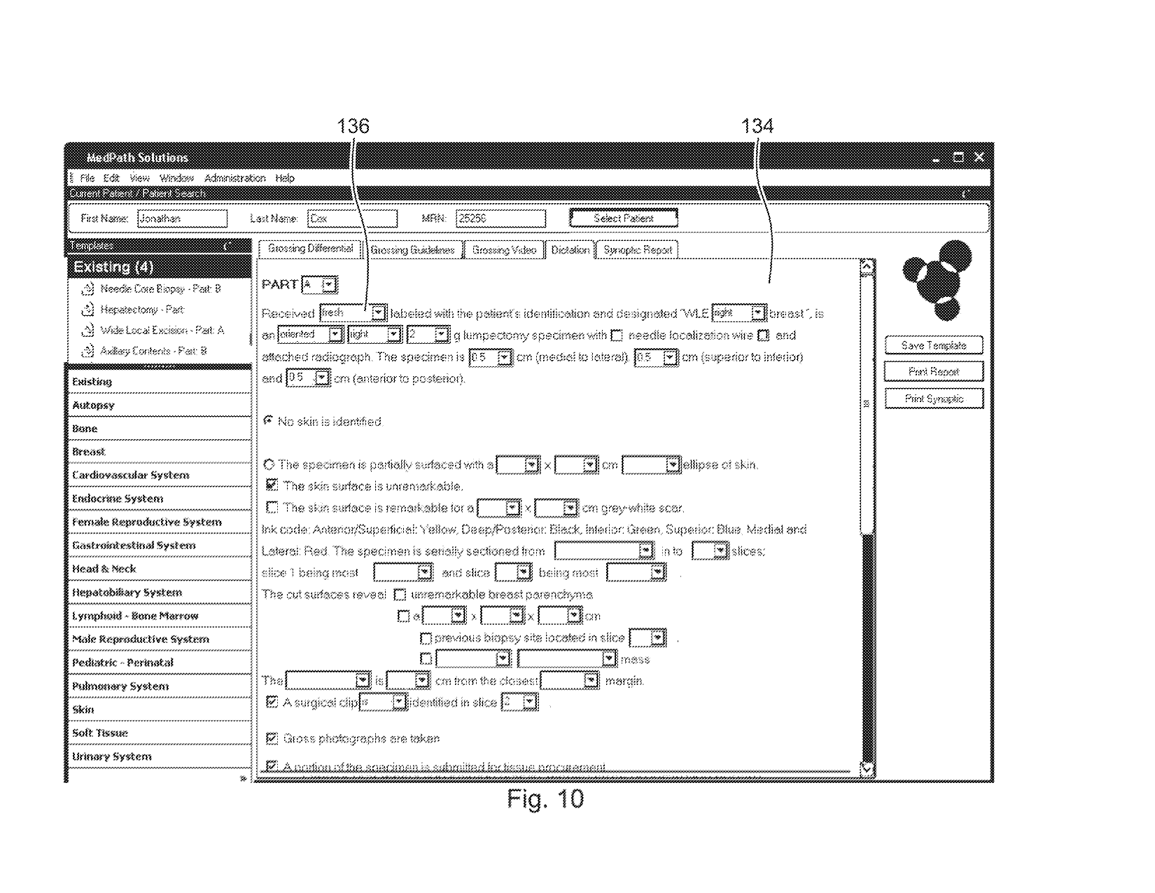

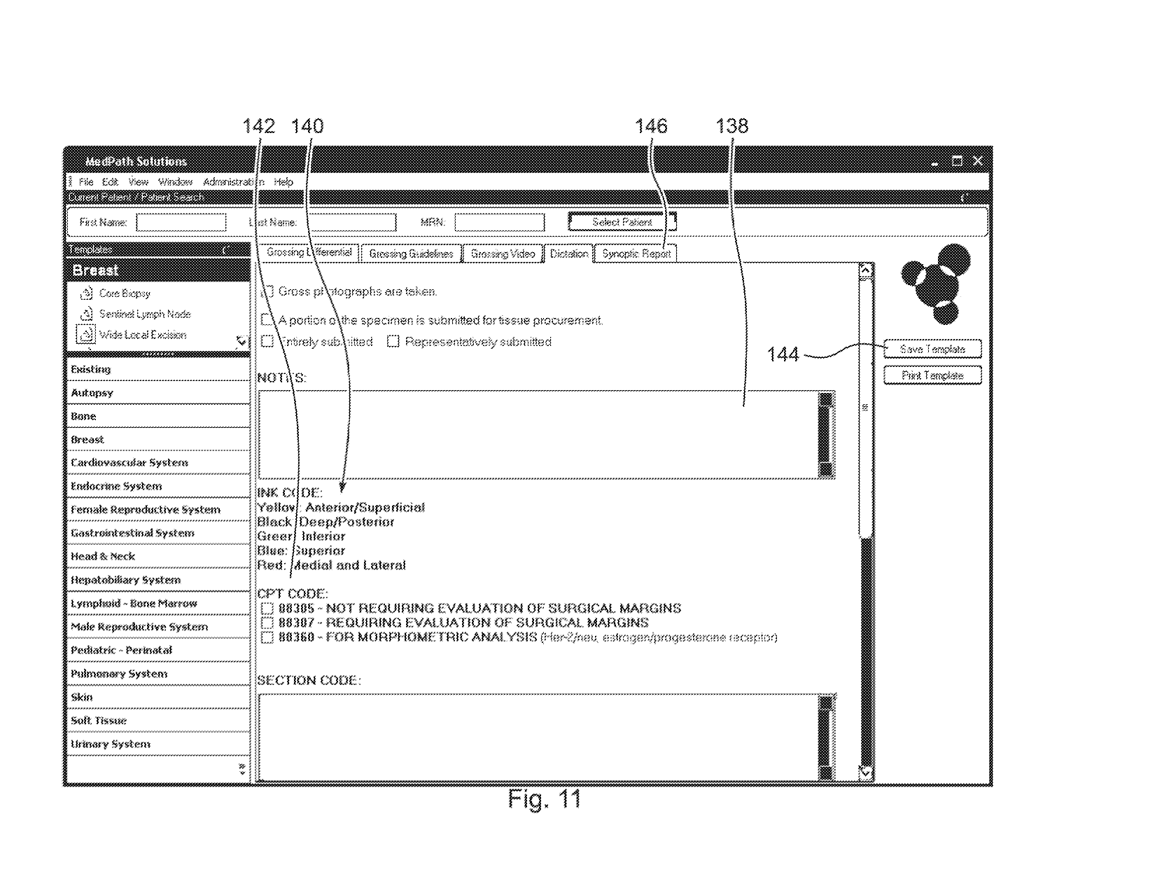

To generate FIGS. 10 and 11, the user selected tab 132 for Dictation in FIG. 9 and field 134 is populated with a facility customizable standardized dictation template according to the specimen type chosen and applicable surgical anatomic pathology operation. The template can be opened and completed using any means known in the art, for example, mouse clicks, keyboard commands, voice recognition commands (such as Dragon Naturally Speaking Medical), or touch screen. In one embodiment, the templates are generated in a way that the user cannot move forward through the dictation without the required information being completed, for example, the user cannot finalize the patient report until all required fields 136 in FIGS. 10 and 11 are completed.

If a gross photograph of the patient specimen is required, the apparatus accepts the photograph as input. The user can input the photo file to the patient file using any means known in the art, for example, JPEG, or PDF, creating a HIPAA compliant specimen photo archive.

In one embodiment, records of gross photographs are included along with any special tissue procurement protocols. In one embodiment, free text note section 138 of any type known in the art, such as MS Word, is available for every specimen and includes medical spell check and voice recognition capabilities (such as Dragon Naturally Speaking) In one embodiment, standard or customizable ink code section 140 is included. In one embodiment, Current Procedural Terminology (CPT) code specimen order box 142 displays at the end of every dictation and includes specimen type suggestions. This enables trained Pathology personnel to order the specimen billing code once the grossing is completed-maximizing laboratory reimbursement by minimizing medical coding errors. Any CPT codes known in the art can be displayed, including codes for special stains and decalcification orders when appropriate.

In one embodiment, by replacing actual patient information and demographics with mock up patient information and demographics, the apparatus can function in a test mode for evaluation by potential users or in a training mode for training users of the apparatus. For example, the training mode can be used as part of Pathologist's Assistant training programs in universities or other educational institutions.

In one embodiment, a customizable user signature, associated with the user login, generates at the end of the dictation using voice recognition or touch screen capabilities. In one embodiment, once the dictation is complete (with boxes that are not required to be filled out, shade out, depending on the specifics) and saved, the drop down options disappear, generating a final patient pathology report using any means known in the art, for example, .NET crystal reports. In one embodiment, once the report is saved, the print template button is enabled. In one embodiment, once the saved template is selected, from the dictation page, the report is saved to a Structured Query Language (SQL) server database using a unique identification based on the selected patient identifiers. In one embodiment, the Existing template group is generated whenever a template is saved, having a number in the title, increasing and indicating the total number of existing templates for that patient. For example, “Existing (2)”. A template option of the appropriate name also is added to the Existing group as a selectable sub-item.

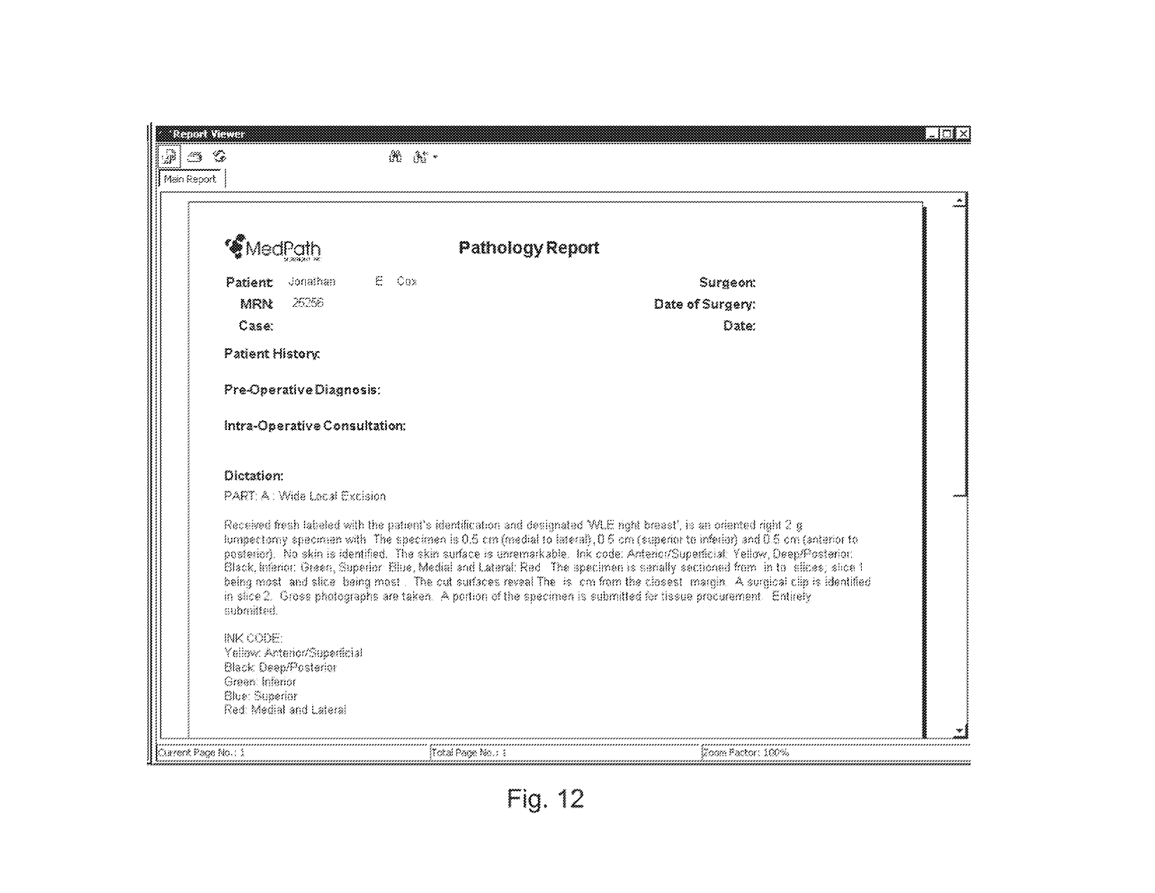

To generate FIG. 12, the user selected tab 144 for Save Template in FIG. 10 or 11. This pathology report is automatically generated by gathering, sorting, and presenting information obtained in the previous figures. In one embodiment, the pathology report is presented using any means known in the art, for example, .NET crystal reports, and has at least three options for enable the user to save the report in any format known in the art, for example, PDF, MS. WORD, and MS EXCEL. The pathology report can be saved in to the patient file so that the Pathologist can access the report and completed their part of the microscopic diagnosis, or the report can be printed out and handled in the same manner.

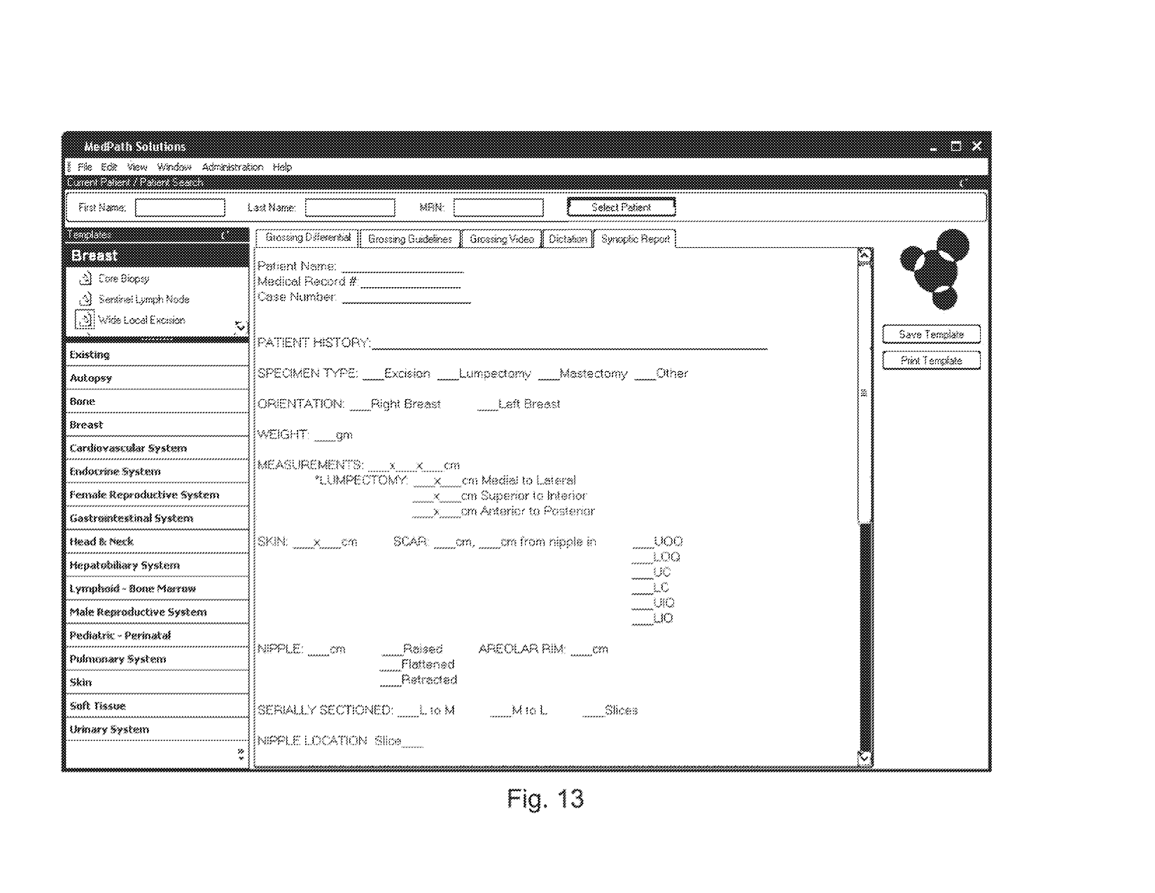

To generate FIG. 13, the user has selected tab 146 for Synoptic Report in FIG. 10 or 11. The information entered in FIGS. 10 and 11 is extracted from the Dictation tab and transferred to the standardized Synoptic Report. Hence, data in the Diction creates the appropriate Synoptic Report that ties to a specific specimen. In one embodiment, a standardized Synoptic Report is generated using any means known in the art, for example, .NET crystal reports, upon saving of a template. This report also has options for the user to save the report in various formats, for example, PDF, MS. WORD, and MS EXCEL. This allows for the option of Pathologists reviewing the grossing pathology report in standard dictation report format or in a standard synoptic report format or both.

In one embodiment, the Synoptic Report provides standardized terminology and pathology report structure to enable recognition of the most important findings in determining treatment, for example, by providing standardized nomenclature, a set of universally required findings, and a consistent report structure. However, the report standardization and format preserves the user's flexibility to offer individual diagnostic opinions on a case-by-case basis by including synoptic elements with narrative descriptions. Thus, a clinician can identify clinically significant elements, while still having access to more subjective material, such as the user's opinion regarding a specimen.

Furthermore, in another preferred embodiment, the system 100 of the present invention is able to distinguish between words of similar meaning. Thus, the possibility of incorrectly diagnosing a patient as a result of word ambiguity is reduced. Such differences in the meanings of words may result in an improper diagnosis due to a misunderstanding of a descriptive word. Word ambiguity also creates problems in correctly searching, compiling and analyzing information, particularly in mining information from synoptic reports. Given the same or similar sample, two users may enter two different words, having similar but slightly different meanings. The intended meaning of a word or words, could be incorrectly interpreted, especially by people having a different skill level or knowledge base. For example, one user may enter the word “malignant” in a synoptic report and a different user may enter the word “cancer” in the same or different synoptic report. Such use of different words having similar but slightly different meanings could cause confusion, as the exact meaning of the words are different, particularly when used within the context of a specific sample.

Therefore, the system 100 of the present invention is designed with features to minimize word ambiguity and the possibility of incorrectly diagnosing a patient based on a misinterpreted word. In one embodiment, the system 100 may comprise an electronic dictionary or database comprising a plurality of words and their associated meanings such that the system 100 is able to compare and contrast between words of differing meanings. In this case, a specific or standardized word may be generated when words of slightly different meaning are entered. Using the prior example, if the word “cancer” is entered, the word “malignant” is generated, thus reducing confusion of different word meanings. Reducing ambiguity of word meaning is especially important in pathology. The misunderstanding of a word could lead to the wrong patient diagnosis. Furthermore, reduction of word ambiguity, particularly in the generation of an output, such as a synoptic report, is important when such information is searched, compiled and analyzed for future research.

In another embodiment, the system 100 may be able to distinguish between meanings of words such that the exact word or words entered by a user are not changed or modified. For example, given a set of words having slightly different meanings, the system 100 may be able to distinguish between them to search, compile, modify and generate standardized instructions that are specific to a sample. Therefore, use of the system 100 is not limited based on a particular user's knowledge of words.

Editing and addendums of saved patient reports are enabled in the apparatus until final sign out, for example, regarding any gross residual tissue, such as decalcification and/or additional tissue sections that may need to be submitted for a case. Once the patient file is saved and the final pathology report is completed, the apparatus is enabled with a customized chosen time frame; for example, 2 months post completion, to enable structured data extraction for cancer registry and research databases.

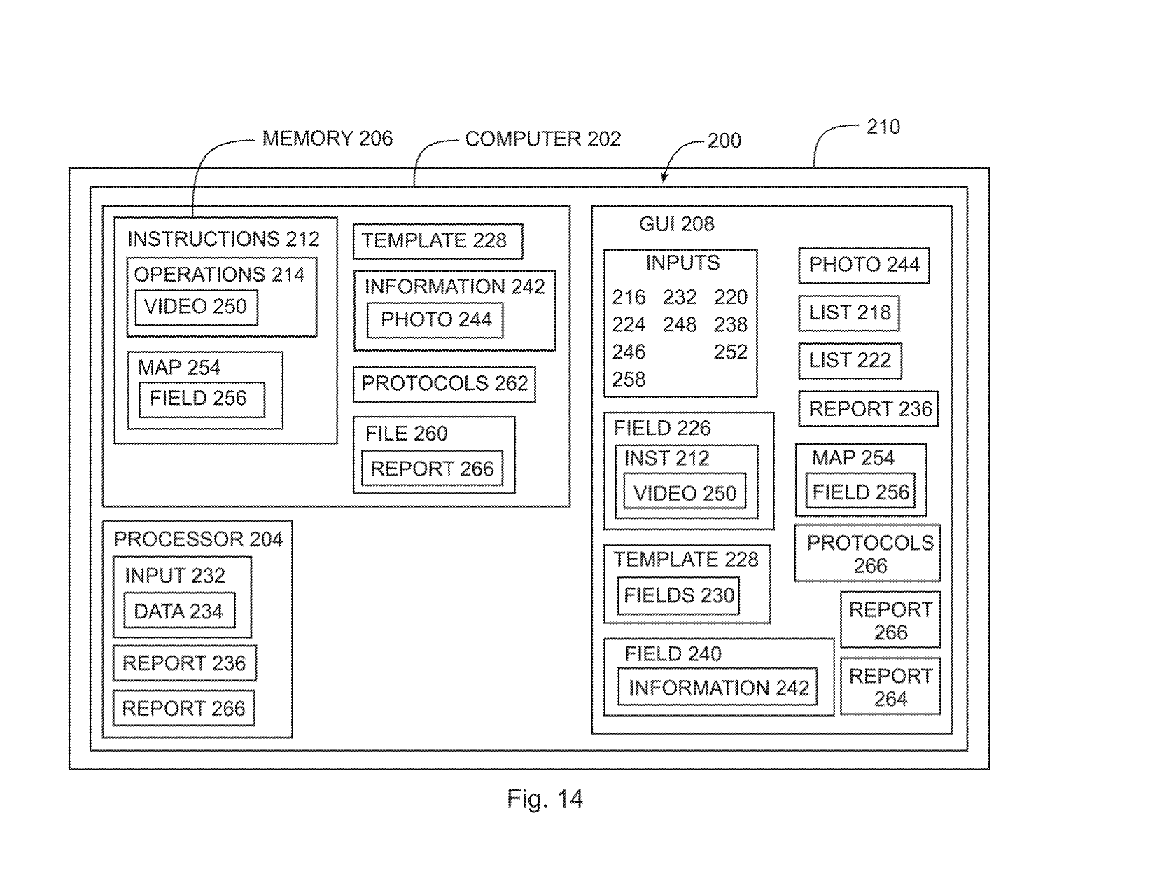

FIG. 14 is a block diagram of computer-based apparatus 200 for guiding surgical anatomic pathology operations. Apparatus 200 includes at least one specially programmable computer 202, processor 204, memory element 206, and graphical user interface (GUI) 208. Computer 202 can be any computer or plurality of computers known in the art. In one embodiment, the computer is located in a single location with which apparatus 200 is associated, for example, location 210. In another embodiment (not shown), all or parts of the computer are remote from a location with which apparatus 200 is associated. In one embodiment, one or more computers 202 are located at respective specimen processing stations. Processor 204 can be any processor known in the art. Memory element 206 and GUI 208 can be any memory element or GUI, respectively, known in the art.

In an embodiment, the memory element may be used for storing a plurality of instructions 212 for guiding surgical anatomic pathology operations 214. Instructions 212 can include any instructions known in the art and operations 214 can include any surgical anatomic pathology operations known in the art. In another embodiment, the GUI is for: receiving input 216 selecting an existing patient or identifying a new patient; displaying a list 218 of human body organs or organ systems; and receiving input 220 selecting an organ or organ system from the list of human body organs or organ systems, for example, as shown in FIG. 1. List 218 can include any human body organ or organ system known in the art. In a preferred embodiment, the GUI is for displaying list 222 including at least one specimen type applicable to the selected human body organ or organ system, for example, as shown in FIG. 2; and receiving input 224 selecting a specimen type from list 222, for example, as shown in FIG. 3. List 222 can include any specimen type known in the art.

In an embodiment, the processor 204 is for selecting instructions 212 for a surgical anatomic pathology operation applicable to the selected specimen type, and populating, using the GUI, field 226 with the instructions 212 applicable to the selected specimen type, for example, as shown in FIG. 5. The processor also displays, using the GUI, dictation template 228, applicable to the surgical anatomic pathology operation. The template includes respective prompts and respective fields 230. The GUI receives input 232 via respective fields including data 234 related to performance of the surgical anatomic pathology operation, for example, as shown in FIG. 10. The processor is for generating pathology report 236 for the existing patient or the new patient including data 234. In one embodiment, for example, as shown in FIG. 12, the processor displays the report on the GUI.

In one embodiment, the memory element is for storing a plurality of dictation templates 228, and the processor is for selecting the dictation template for display from the plurality of dictation templates, for example, by determining which of the stored templates is most applicable to the surgical anatomic pathology operation.

In one embodiment, the memory element is for storing a plurality of standardized prompts and information 242 applicable to respective human body organs or organ systems. The GUI is for receiving input 238 selecting grossing differentials, and the processor is for selecting standardized prompts and information, applicable to the selected human body organ or organ system, from the plurality of standardized prompts and information.

In another embodiment, the processor 204 may be used to select standardized prompts and information 242 applicable to respective human body organs or organ systems based on the input 232 from a user. Such input 232 may include tissue attributes or characteristics such as weight, color, dimensions, pathological tissue condition, and/or other pathology related attributes. The processor 204 may be used to run a computer algorithm that enables the system 100 to search, identify and/or compile items within the library of standardized prompts and instructions. In a preferred embodiment, these standardized prompts and instructions are associated with tissue attribute data and other tissue pathology information entered into the system 100 by a user.

Furthermore, the processor 204 may be used to search, identify and/or compile related educational information and/or medical history information. Such information may be searched, identified and/or compiled based on keywords or terms related to the tissue attributes that are entered by a user. For example, the processor may search the database of information based on key attributes such as tissue color, or tissue condition. This information may be displayed or generated in a report to further instruct and guide a user in performing the pathology analysis. In a preferred embodiment, the compilation and modification of outputted information, such as standardized instructions and prompts, is dependent on the unique specific tissue attribute information that is entered into the system 100 by a user.

In an embodiment, the GUI populates field 240 on the GUI with the selected standardized prompts and information 242, for example, as shown in FIG. 3. In one embodiment, the standardized prompts and information include respective photographs 244 applicable to human body organs or organ systems 214. As shown for example in FIG. 4, the GUI is for displaying, using the processor, at least one respective photograph 244 applicable to the selected human body organ or organ system.

In one embodiment, instructions 212 include respective videos 250 applicable to surgical anatomic pathology operations 214. As shown for example in FIG. 9, the GUI is for displaying, using the processor, respective video 250 applicable to the surgical anatomic pathology operation.

In another embodiment, instructions 212 include at least one diagram-map 254, for example, as shown in FIG. 7. The processor identifies a respective diagram-map 254 applicable to the surgical anatomic pathology operation, and displays, using the GUI, the respective diagram-map. In one embodiment, the respective diagram-map includes at least one field 256. The GUI is for receiving data input 258 including respective locations for tissue samples taken as part of the surgical anatomic pathology operation. The processor is for saving the data input to a file for the existing patient or the new patient. In one embodiment, file 260 for the existing patient or the new patient is stored in the memory element.

In an embodiment, the GUI displays facility customizable standardized instructions and protocols 262 to procure tissue for research and clinical data analysis, for example, as shown in FIG. 8. The standardized instructions and protocols are specimen type specific. The facility customizable standardized instructions and protocols 262 are stored in the memory element and the processor can accept input to customize facility customizable standardized instructions and protocols 262.

Since each tissue sample is unique, it is important that the system of the present invention be capable of compiling and displaying standardized prompts and instructions that are dependent on specimen type as well as tissue characteristics and attributes. In an embodiment, the processor 204 may be used to perform an algorithm that queries previously stored information, protocols and/or instructions based on unique tissue characteristic and attribute information that is entered. Such an algorithm may comprise at least one Boolean search that associates data and information, i.e. words, letters, numbers or combinations thereof, in a particular order based on information obtained in situ while performing the pathology analysis. This ability to further customize outputs and reports of prompts, instructions and pathology tissue data, further the guides the user in performing intricate and/or complex pathology analysis.

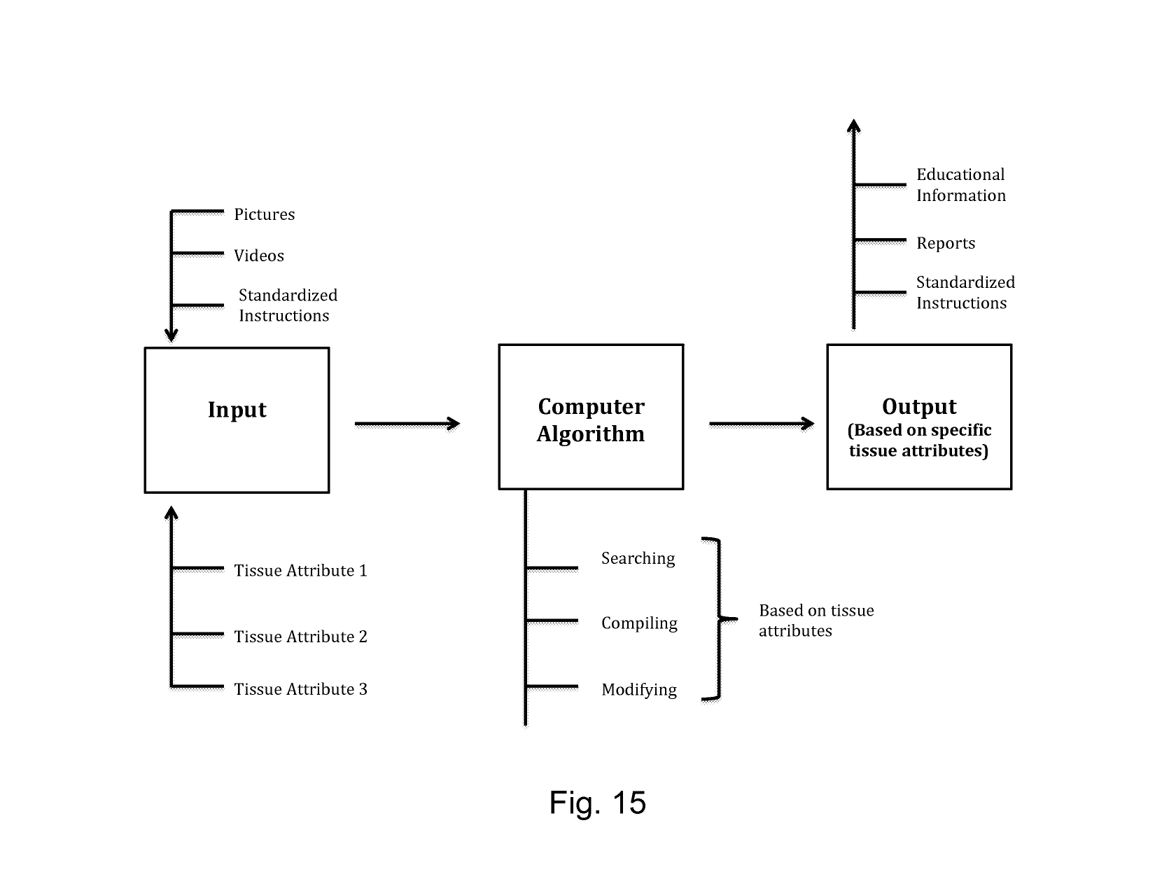

FIG. 15 illustrates a diagram of an embodiment of the system 100 of the present invention. As shown, the system 100 comprises a series of inputs such as a plurality of standardized instructions, pictures and/or videos. Using the computerized processing capabilities, a series of functions comprising a search, a compilation or a modification of the inputs is performed based on specific tissue attributes. For example, a search of the standardized instructions may be performed based on a keyword or keywords of the tissue attributes that are entered by a user.

This information is compiled by the processor 204 and displayed using the GUI. If a second tissue attribute is entered into the system 100, the processor performs another search of the stored information and compiles the information. In addition, this compiled information may be further modified and customized based on the entered tissue attribute information. After modification, the standardized instructions may be displayed or outputted in a report. Furthermore, educational information may be outputted as well. In either case, the algorithm operates based on specific tissue information, i.e., tissue attributes, that are entered by a user. Therefore, a customized set of instructions may be generated based on specific and unique tissue attribute information that is entered by a user.

In an embodiment, the processor 204 may generate a pathology report 264, for example, as shown in FIG. 12, using applicable data obtained via the operations described supra. In a preferred embodiment, the report 264 is displayed on the GUI. In one embodiment, the pathology report is saved to a patient file 260 so that a pathologist can access the report and completed their part of the microscopic diagnosis. The report can be printed out and handled in the same manner.

In an embodiment, the processor 20 generates pathology report 266, for example, as shown in FIG. 13. As shown report 266 is displayed on the GUI. In one embodiment, the synoptic report is saved to patient file 260.

Apparatus 100 provides guided decision support that emphasizes and ensures patient safety, minimizes redundancies and transposed errors, compensates for lack of national standards for grossing, enables automatic dictation, and facilitates tissue sampling and tissue procurement for research. Apparatus 100 is compliant with recommendation of the College of Pathologists regarding final synoptic reports that the Pathologist complete for microscopic diagnosis and supports future cancer reporting guidelines for grossing.

In one embodiment, the system generates a data file of patient demographics and pathology results, for example, tumor data, for cancer or research reporting. In one embodiment, the system is compliant with Health Insurance Portability and Accountability Act (HIPPA) requirements. In one embodiment, the system tracks specimen data for use with audit trails.

In one embodiment, the system can be used in a “teaching” mode, for example, available to pathologist assistant training schools or students, using mock up patient demographics.

According to aspects disclosed herein there is provided a standardized method for guiding decision support for surgical anatomic pathology operations, for example, as shown in FIGS. 1-15.

The apparatus and method described supra:

1. Increases hospital-lab profits by minimizing medical coding errors.

2. Increase efficiency and accuracy of surgical grossing specimen, reducing patient report turn around time.

3. Minimizes transcription errors and costs by enabling voice recognition and touch screen capabilities.

4. Provides a chain of specimen handling with custom electronic signatures.

5. Uses forced data entry to avoid incomplete dictation specimen reports.

6. Provides a simplified approach to handling unfamiliar specimens and routine autopsy cases.

Thus, it is seen that the objects of the disclosure are efficiently obtained, although changes and modifications to the disclosure should be readily apparent to those having ordinary skill in the art, without departing from the spirit or scope of the disclosure as claimed. Although the disclosure is described by reference to an example embodiment, it is clear that variations can be made without departing from the scope or spirit of the disclosure as described.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the disclosed disclosure.

What is claimed is:

1. A computer-based method for guiding decision support for surgical anatomic pathology operations, comprising the following steps:
a) providing a programmable computer comprising a processor, a display, at least one user interface device and a memory element;
b) storing a plurality of surgical anatomic pathology instructions in the memory element of the programmable computer;
c) receiving, using a graphical user interface (GUI), a first tissue attribute input;
d) accepting, using the processor, the first tissue attribute input;
e) searching, using the processor, the plurality of surgical anatomic pathology instructions associated with the first tissue attribute;
f) compiling a set of surgical anatomic pathology instructions associated with the first tissue attribute;
g) modifying, using the processor, the set of compiled surgical anatomic pathology instructions according to the first tissue attribute input, wherein the set of instructions and protocols are specimen specific; and
h) displaying, using the GUI and the processor, the compiled and modified plurality of the set of compiled surgical anatomic pathology instructions according to the first tissue attribute input.

2. The computer-based method of claim 1 further providing:
a) receiving, using a graphical user interface (GUI), a second tissue attribute input;
b) accepting, using the processor, the second tissue attribute input;
c) searching, using the processor, the plurality of surgical anatomic pathology instructions associated with the second tissue attribute; and
d) compiling a set of surgical anatomic pathology instructions associated with the first and second tissue attributes;
e) modifying, using the processor, the set of compiled surgical anatomic pathology instructions according to the first and second tissue attribute inputs, wherein the set instructions and protocols are specimen specific; and
f) displaying, using the GUI and the processor, the compiled and modified plurality of the set of compiled surgical anatomic pathology instructions according to the first and second tissue attribute inputs.

3. The computer-based method of claim 2 further generating a report comprising the tissue attributes.

4. The computer-based method of claim 1 further displaying, using the GUI and the processor, a dictation template with respective prompts and respective fields applicable to the surgical anatomic pathology operation.

5. The computer-based method of claim 4 further receiving, using the GUI, a third tissue attribute.

6. The computer-based method of claim 5 further providing the first, second, or third tissue attribute comprising, a human body organ or organ system, a tissue weight, a tissue dimension, tissue color, or tissue pathological condition.

7. The method of claim 1 further storing, in the memory element, a plurality of dictation templates; and, selecting, using the processor, a dictation template, from the plurality of dictation templates, applicable to the surgical anatomic pathology operation.

8. The method of claim 1 further comprising the following steps:
a) storing, using the memory element, a plurality of standardized prompts and information applicable to respective human body organs or organ systems;
b) selecting, using the processor, standardized prompts and information, applicable to a selected human body organ or organ system, from the plurality of standardized prompts and information; and
c) populating, using the processor, a field on the GUI with the selected standardized prompts and information.

9. The method of claim 8 further providing the plurality of standardized prompts and information includes respective photographs; and, populating the second field includes displaying a respective photograph applicable to the selected human body organ or organ system.

10. The method of claim 1 further selecting, from the plurality of instructions for guiding surgical anatomic pathology operations and using the processor, the instructions applicable to the surgical anatomic pathology operation.

11. The method of claim 1 further storing a plurality of instructions for guiding surgical anatomic pathology operations including storing a respective video; and, populating a first field with instructions includes displaying the respective video.

12. The method of claim 1 further providing the following steps:
a) storing, in the memory element, at least one diagram-map for use in showing respective locations for tissue samples;
b) identifying, using the processor, the diagram-map applicable to the surgical anatomic pathology operation;
c) populating the respective diagram-map with demographics for a patient; and
d) displaying, using the GUI and the processor, the respective diagram-map.

13. The method of claim 12 further providing the diagram-map with a respective photograph; and, displaying the respective photograph applicable to the selected human body organ or organ system on the diagram-map.

14. A computer-based system for guiding decision support for surgical anatomic pathology operations, comprising:
a) a programmable device capable of digital processing, a display, at least one user interface device, a memory element, and a graphical user interface (GUI);
b) a plurality of surgical anatomic pathology instructions, programmed into the memory element of the programmable device, wherein the surgical anatomic pathology instructions are tissue specimen specific;
c) at least one anatomic pathology tissue attribute, entered by a user, into the memory element through the GUI; and
d) wherein the processor is capable of generating a customized output dictated by the entered anatomic pathology tissue attribute.

15. The system of claim 14 wherein the customized output comprises a plurality of standardized surgical anatomic pathology instructions or protocols, a report comprising the least one anatomic pathology tissue attribute and/or educational pathology information.

16. The system of claim 14 wherein the customized output is characterized as having been created by the processor performing an algorithm that associates the plurality of surgical anatomic pathology instructions with the at least one entered anatomic pathology tissue attribute.

17. The system of claim 14 wherein the tissue attribute comprises a human body organ or organ system, tissue weight, tissue dimension, tissue color, or tissue pathological condition.

18. The system of claim 14 further comprising a picture and/or a video programmed into the memory element.

19. The system of claim 14 further comprising the plurality of surgical anatomic pathology instructions and/or the least one anatomic pathology tissue attribute stored on the world wide web, accessible by the programmable device.

20. A computer-based system for guiding decision support for surgical anatomic pathology operations, comprising:
a) a programmable device capable of digital processing, a display, at least one user interface device, a memory element, and a graphical user interface (GUI);
b) a plurality of surgical anatomic pathology instructions, programmed into the memory element of the programmable device, wherein the surgical anatomic pathology instructions are tissue specimen specific;
c) at least one anatomic pathology tissue attribute, comprising a human body organ or organ system, tissue weight, tissue dimension, tissue color, or tissue pathological condition, entered by a user, into the memory element through the GUI and into a dictation template; and
d) wherein the processor is capable of generating a customized output determined by the entered anatomic pathology tissue attribute, the output characterized as having been created by the processor performing an algorithm.
